(19) United States
(12) Patent Application Publication
(10) Pub. No.: US 2007/0254996 A1
(43) Pub. Date: Nov. 1, 2007

(54) Nanocrystal-polymer composite materials and methods of attaching nanocrystals to polymer molecules

(76) Inventors: Krzysztof Nauka, Palo Alto, CA (US); Zhang-Lin Zhou, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/413,792

(22) Filed: Apr. 28, 2006

(51) Int. Cl. C04B 26/12; C08K 3/32; C08K 3/30; C08K 3/10; C08K 3/08

(52) U.S. Cl. 524/408; 524/414; 524/418; 524/434; 524/440

(57) ABSTRACT

Nanocrystal-polymer composite materials include nanocrystals chemically attached to molecules of a polymer matrix material by way of a chemical complex or a covalent bond. Electronic devices include an anode, a cathode, and such nanocrystal-polymer composite materials disposed between the anode and the cathode. Methods of chemically attaching each of a plurality of nanocrystals to at least one molecule of a polymer matrix material include coating the nanocrystals with ligands that each include a binding group and a first functional group, providing a polymer material having a second functional group covalently bonded thereto, and reacting the first functional groups with the second functional groups to form covalently bonded links. Additional methods include providing a polymer material having binding groups covalently attached to molecules thereof, providing a plurality of nanocrystals, and forming a chemical complex or a covalent bond between each nanocrystal and a bind group.

### FIELD OF THE INVENTION

The present invention relates to nanocrystal-polymer composite materials, electronic and optoelectronic devices including nanocrystal-polymer composite materials, and methods of attaching nanocrystals to molecules of polymer materials.

### BACKGROUND OF THE INVENTION

Nanocrystal-polymer composite materials are polymer-based materials that include a plurality of nanocrystals. Typically, the nanocrystals are randomly dispersed throughout the polymer matrix. For example, nanocrystal-polymer composite materials have been proposed that include nanocrystals such as PbS, CdTe, and CdSe randomly dispersed throughout polymer materials.

To fabricate such nanocrystal-polymer composite materials, it has been proposed to fabricate the nanocrystals and the polymer material separately, and to then mix the pre-fabricated nanocrystals with the pre-fabricated polymer material. Nanocrystals have also been formed or grown in situ within a polymer matrix. Moreover, nanocrystal colloids have been prepared and a polymer matrix has been formed in situ around the nanocrystals from polymer precursor materials.

In known nanocrystal-polymer composite materials, however, the nanocrystals are not chemically attached (through chemical bonds or chemical complexes) to the polymer matrix material, but are merely physically mixed with, and retained within, the polymer matrix material. Such nanocrystal-polymer composite materials may be unstable, and phase segregation may occur between the nanocrystals and the polymer matrix material, thereby hindering or preventing the formation of nanocrystal-polymer composite materials having uniform distributions of nanocrystals in the polymer matrix material.

Nanocrystal-polymer composite materials have been used or proposed for use in many electronic and optoelectronic devices, including, for example, light-emitting diodes, display devices, electromagnetic radiation sensors, lasers, photovoltaic cells, photo-transistors, and modulators.

### BRIEF SUMMARY OF THE INVENTION

In one aspect, the present invention includes novel nanocrystal-polymer composite materials in which nanocrystals are chemically attached to molecules of a polymer matrix material. The nanocrystals may be attached to molecules of the polymer matrix material by a chemical complex or a covalent bond therebetween.

In another aspect, the present invention includes a method of chemically attaching each of a plurality of nanocrystals to at least one molecule of a polymer matrix material. The method includes coating a plurality of nanocrystals with ligands having a chemical structure represented as:
BG-Z-FG_{1,}
wherein BG is a binding group independently selected from the group consisting of a primary amine, a secondary amine, a tertiary amine, an amide, a nitrile, an isonitrile, a cyanate, an isocyanate, a thiocyanate, an isothiocyanate, an azide, a thio, a thiolate, a sulfide, a sulfinate, a sulfonate, a phosphate, a hydroxyl, an alcoholate, a phenolate, a carbonyl, a carboxylate, a phosphine, a phosphine oxide, a phosphonic acid, a phosphoramide, a phosphate, and a phosphate; Z is a covalent bond or chemical structure providing a covalent bond between BG and FG₁; and FG₁ is a first functional group. The method further includes providing a polymer material having a chemical structure represented as: 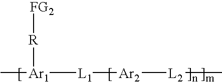
wherein Ar₁ and Ar₂ each comprise an aromatic ring system, R is a covalent bond or chemical structure providing a covalently bonded link between FG₂ and AR₁; FG₂ is a second functional group configured to react with the first functional group FG₁ to provide a covalently bonded link between BG and Ar₁; L₁, and L₂ each comprise a covalent bond or chemical structure providing a covalently bonded link; m is an integer greater than about 1,000; and n is an integer between 1 and about 5,000. The FG₂ groups are reacted with the FG₁ groups to form covalently bonded links between BG and Ar1.

In another aspect, the present invention includes a method of chemically attaching each of a plurality of nanocrystals to at least one molecule of a polymer matrix material. The method includes providing a polymer material having a chemical structure represented as: 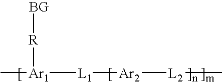
wherein BG is a binding group independently selected from the group consisting of a primary amine, a secondary amine, a tertiary amine, an amide, a nitrile, an isonitrile, a cyanate, an isocyanate, a thiocyanate, an isothiocyanate, an azide, a thio, a thiolate, a sulfide, a sulfinate, a sulfonate, a phosphate, a hydroxyl, an alcoholate, a phenolate, a carbonyl, a carboxylate, a phosphine, a phosphine oxide, a phosphonic acid, a phosphoramide, a phosphate, and a phosphate; Ar₁ and Ar₂ each comprise an aromatic ring system; R is a covalent bond or chemical structure providing a covalently bonded link between FG₂ and AR₁; L₁ and L₂ each comprise a covalent bond or chemical structure providing a covalently bonded link; m is an integer greater than about 1,000; and n is an integer between 1 and about 5,000. The method further includes providing a plurality of nanocrystals and forming a chemical complex or a covalent bond between each nanocrystal and a binding group BG.

In yet another aspect, the present invention includes a method of chemically attaching each of a plurality of nanocrystals to at least one molecule of a polymer matrix material. The method includes coating a plurality of nanocrystals with ligands having a chemical structure represented as:
BG-Z-FG_{1,}
wherein BG is a binding group independently selected from the group consisting of a primary amine, a secondary amine, a tertiary amine, an amide, a nitrile, an isonitrile, a cyanate, an isocyanate, a thiocyanate, an isothiocyanate, an azide, a thio, a thiolate, a sulfide, a sulfinate, a sulfonate, a phosphate, a hydroxyl, an alcoholate, a phenolate, a carbonyl, a carboxylate, a phosphine, a phosphine oxide, a phosphonic acid, a phosphoramide, a phosphate, and a phosphate; Z is a covalent bond or chemical structure providing a covalent bond between BG and FG₁; and FG₁ is a first functional group. The method further includes providing a polymer material having a chemical structure represented as: 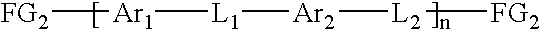
wherein Ar₁ and Ar₂ each comprise an aromatic ring system, R is a covalent bond or chemical structure providing a covalently bonded link between FG₂ and AR₁, FG₂ is a second functional group configured to react with the first functional group FG₁ to provide a covalently bonded link between BG and Ar₁, L₁ and L₂ each comprise a covalent bond or chemical structure providing a covalently bonded link, and n is an integer between 1 and about 5,000. The FG₂ groups are reacted with the FG₁ groups to form covalently bonded links.

In an additional aspect, the present invention includes an electronic device comprising at least one light-emitting diode that includes an anode, a cathode, and a luminescent nanocrystal-polymer composite material disposed between at least a portion of the anode and a portion of the cathode. The luminescent nanocrystal-polymer composite material includes a polymer matrix material and a plurality of nanocrystals, and a chemical complex or a covalent bond chemically attaches each nanocrystal to a molecule of the polymer matrix material.

### BRIEF DESCRIPTION OF THE SEVERAL VIEWS OF THE DRAWINGS

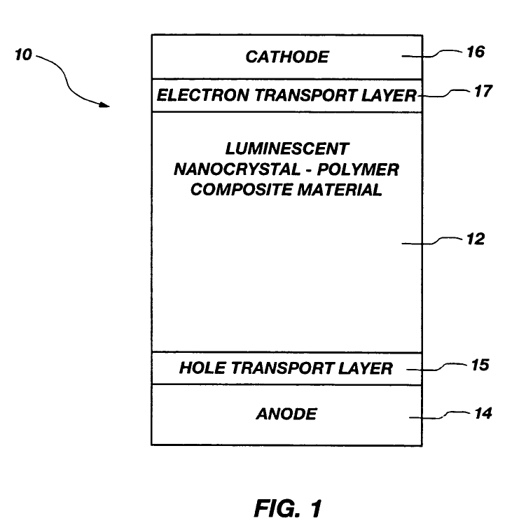

While the specification concludes with claims particularly pointing out and distinctly claiming that which is regarded as the present invention, the advantages of this invention can be more readily ascertained from the following description of the invention when read in conjunction with the accompanying drawing in which FIG. 1 is a schematic diagram of an embodiment of a light-emitting diode that includes a nanocrystal-polymer composite material.

### DETAILED DESCRIPTION OF THE INVENTION

As used herein, the term “nanocrystal” means a particle of matter having cross-sectional dimensions of less than about 1000 nanometers and a generally crystalline atomic structure. The term “luminescent nanocrystal” means a nanocrystal that is capable of emitting electromagnetic radiation upon stimulation. The term “III-V type semiconductor material” means any material that comprises an element or elements from group IIIB of the periodic table (B, Al, Ga, In, and Ti) and an element or elements from group VB of the periodic table (N, P, As, Sb, and Bi). The term “II-VI type semiconductor material” means any material that comprises an element or elements from group IIB of the periodic table (Zn, Cd, and Hg) and an element or elements from group VIB of the periodic table (O, S, Se, Te, and Po).

As used herein, the term “heteroatom” means nitrogen, oxygen, or sulfur. The terms “halo” and “halogen” mean a fluoro, chloro, bromo, or iodo substituent. The term “cyclic” means having an alicyclic or aromatic ring structure, which may or may not be substituted, and may or may not include one or more heteroatoms. Cyclic structures include monocyclic structures, bicyclic structures, and polycyclic structures. The term “alicyclic” is used to refer to an aliphatic cyclic moiety, as opposed to an aromatic cyclic moiety.

As used herein, the term “aromatic ring system” includes monocyclic rings, bicyclic ring systems, and polycyclic ring systems, in which the monocyclic ring, or at least a portion of the bicyclic ring system or polycyclic ring system, is aromatic (i.e., the Hückel rule is satisfied). The monocyclic rings, bicyclic ring systems, and polycyclic ring systems of the aromatic ring systems described herein may include carbocyclic rings and/or heterocyclic rings. The term “carbocyclic ring” denotes a ring in which each ring atom is carbon. The term “heterocyclic ring” denotes a ring in which at least one ring atom is not carbon and comprises 1 to 4 heteroatoms.

As used herein, the term “alkyl” means a branched, unbranched, or cyclic saturated hydrocarbon group, which typically, although not necessarily, contains from 1 to about 24 carbon atoms. Alkyls include, but are not limited to, methyl, ethyl, n-propyl, isopropyl, n-butyl, isobutyl, t-butyl, octyl, decyl, and the like, as well as cycloalkyl groups such as cyclopentyl, cyclohexyl and the like. The term “lower alkyl” means an alkyl group having from 1 to 6 carbon atoms. As used herein, the term “substituted alkyl” means an alkyl substituted with one or more substituent groups. The term “heteroalkyl” means an alkyl in which at least one carbon atom is replaced with a heteroatom. If not otherwise indicated, the term “alkyl” includes unsubstituted alkyls, substituted alkyls, lower alkyls, and heteroalkyls.

As used herein, the term “alkenyl” means a linear, branched or cyclic hydrocarbon group of 2 to about 24 carbon atoms containing at least one double bond, such as ethenyl, n-propenyl, isopropenyl, n-butenyl, isobutenyl, octenyl, decenyl, tetradecenyl, hexadecenyl, eicosenyl, tetracosenyl, and the like. Alkenyls described herein may contain, but are not limited to, 2 to about 18 carbon atoms. The term “lower alkenyl” means an alkenyl having from 2 to 6 carbon atoms. The term “substituted alkenyl” means an alkenyl or cycloalkenyl substituted with one or more substituent groups. The term “heteroalkenyl” means an alkenyl or cycloalkenyl in which at least one carbon atom is replaced with a heteroatom. If not otherwise indicated, the term “alkenyl” includes unsubstituted alkenyls, substituted alkenyls, lower alkenyls, and heteroalkenyls.

As used herein, the term “alkylene” means a linear, branched or cyclic alkyl group in which two hydrogen atoms are substituted at locations in the alkyl group. Alkylene linkages thus include —CH₂—CH₂— and —CH₂—CH₂—CH₂—, as well as substituted versions thereof wherein one or more hydrogen atoms is replaced with a nonhydrogen substituent. As used herein, the term “heteroalkylene” means an alkylene wherein one or more of the methylene units is replaced with a heteroatom. If not otherwise indicated, the term “alkylene” includes heteroalkylenes.

As used herein, the term “alkenylene” means an alkylene containing at least one double bond, such as ethenylene (vinylene), n-propenylene, n-butenylene, n-hexenylene, and the like. The term “lower alkenylene” refers to an alkenylene group containing from 2 to 6 carbon atoms.

As used herein, the term “alkoxy” means an alkyl group bound to other chemical structure through a single, terminal ether linkage. An alkoxy group may be represented as —O-Alkyl. As used herein, the term “lower alkoxy” means an alkoxy group, wherein the alkyl group contains from 1 to 6 carbon atoms, and includes, for example, methoxy, ethoxy, n-propoxy, isopropoxy, t-butyloxy, etc. The term “aryl” means a group containing a single aromatic ring or multiple aromatic rings that are fused together, directly linked, or indirectly linked (such that the different aromatic rings are bound to a common group such as a methylene or ethylene moiety). Aryl groups described herein may contain, but are not limited to, from 5 to 20 carbon atoms. Aryl groups include, for example, phenyl, naphthyl, biphenyl, diphenylether, diphenylamine, benzophenone, and the like. The term “substituted aryl” refers to an aryl group comprising one or more substituent groups. The term “heteroaryl” means an aryl group in which at least one carbon atom is replaced with a heteroatom. If not otherwise indicated, the term “aryl” includes unsubstituted aryls, substituted aryls, and heteroaryls.

As used herein, the term “hydrocarbyl” means a univalent group formed by removing a hydrogen atom from a hydrocarbon. Hydrocarbyls described herein may contain, but are not limited to, from 1 to about 30 carbon atoms. Hydrocarbyl groups may be linear, branched, or cyclic, and may be saturated or unsaturated. Hydrocarbyl groups may include univalent radicals of alkyl groups, alkenyl groups, aryl groups, and the like. The term “lower hydrocarbyl” means a hydrocarbyl group containing from 1 to 6 carbon atoms. The term “substituted hydrocarbyl” means a hydrocarbyl group that comprises one or more substituent groups. The term “heterohydrocarbyl” means a hydrocarbyl group in which at least one carbon atom is replaced with a heteroatom.

As used herein, the term “hydrocarbylene” means a divalent hydrocarbyl group containing from 1 to about 30 carbon atoms. Hydrocarbylene groups may be linear, branched, or cyclic, and may be saturated or unsaturated. The term “lower hydrocarbylene” means a hydrocarbylene group containing from 1 to 6 carbon atoms. The term “substituted hydrocarbylene” means a hydrocarbylene comprising one or more substituent groups. The term “heterohydrocarbylene” means a hydrocarbylene in which at least one carbon atom is replaced with a heteroatom. Unless otherwise indicated, the term “hydrocarbylene” includes substituted hydrocarbylenes, unsubstituted hydrocarbylenes, lower hydrocarbylenes, and heterohydrocarbylenes.

In the reaction schemes described herein, the colon symbol is used to represent a chemical complex between the atoms or groups on either side of the colon.

In many situations, it may be necessary or desirable to provide nanocrystal-polymer composite materials in which the nanocrystals are chemically attached to the polymer matrix material. For example, it has been proposed to use nanocrystal-polymer composite materials that include luminescent nanocrystals in a conductive polymer matrix material in polymer-based, light-emitting diodes (PLED's). In such applications, charge carriers (i.e., electrons and holes) are introduced into the conductive polymer matrix material from an anode and a cathode of the PLED device. These charges are transferred from the conductive polymer matrix to the luminescent nanocrystals, which emit electromagnetic radiation (e.g., light) as electrons and holes recombine therein. To facilitate enhancement of the efficiency by which charge carriers are transferred from the conductive polymer matrix material to the luminescent nanocrystals, it may be necessary or desirable to chemically attach the luminescent nanocrystals to the molecules of the conductive polymer matrix material.

As another example, in some situations, it may be desirable to provide a uniform distribution of nanocrystals throughout a polymer matrix material. Such a uniform distribution may be provided by chemically attaching the nanocrystals to the molecules of the polymer matrix material at selected locations in the repeating molecular structure of the polymer backbone in the polymer matrix material.

In one aspect, the present invention includes nanocrystal-polymer composite materials in which the nanocrystals are chemically attached to the molecules of the polymer matrix material. In other words, the nanocrystals may be chemically bound to the molecules of the polymer matrix material, or a chemical complex may be formed between a functional group on the molecules of the polymer matrix material and the nanocrystals. In this manner, more intimate structural and electrical coupling may be provided between the nanocrystals and the molecules of the polymer matrix material. In another aspect, the present invention includes electronic devices and optoelectronic devices that include such nanocrystal-polymer composite materials. In yet another aspect, the present invention includes methods that may be used to form such nanocrystal-polymer composite materials.

In one embodiment of the present invention, ligands can be provided and chemically attached to a plurality of nanocrystals. The ligands may include a binding group that is configured to form a chemical bond or a chemical complex with a nanocrystal. The ligands may also include a functional group that is configured to react with a complementary functional group provided on a molecule of a polymer matrix material. The nanocrystals having the ligands bound thereto then may be mixed with the molecules of the polymer matrix material, and the complementary functional groups may be reacted with one another to form a covalently bonded link. This general Reaction is set forth below as Reaction (I).

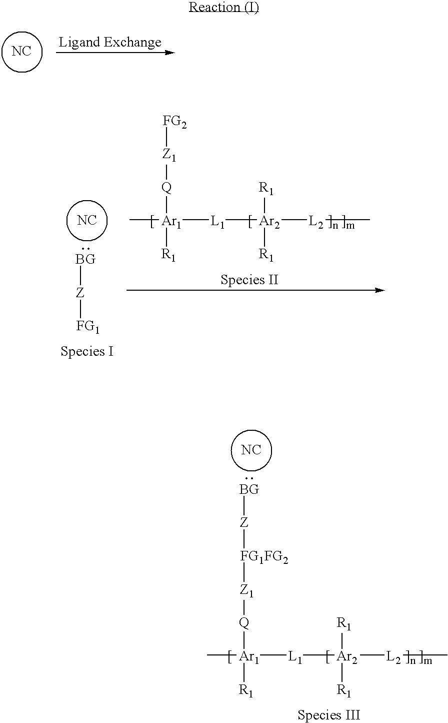

In Reaction (I) as set forth above, NC is a nanocrystal, Species I is a nanocrystal having a ligand chemically attached thereto, Species II is a polymer material, Species III is a nanocrystal-polymer composite material in which nanocrystals are chemically attached to molecules of the polymer matrix material, BG is a binding group, FG₁ is a first functional group, FG₂ is a second functional group that is capable of reacting with the first functional group FG₁ to form a covalently bonded link therebetween, FG₁FG₂ is the resulting chemical structure formed by a reaction between FG₁ and FG₂, Q may be a carbon atom or a heteroatom, Z represents optional chemical structure providing a covalently bonded link between the binding group BG and the first functional group FG₁, Z₁ represents optional chemical structure providing a covalently bonded link between Q and the second functional group FG₂, Ar₁ represents a first aromatic ring system, Ar₂ represents a second aromatic ring system, and L₁ and L₂ represent optional chemical structure providing a covalently bonded link between Ar₁ and Ar₂. Moreover, each R₁ represents optional additional chemical structure.

In some embodiments of the present invention, each nanocrystal NC may have cross-sectional dimensions in a range extending from about 1 nanometer to about 500 nanometers. In additional embodiments, each nanocrystal NC may have cross-sectional dimensions in a range extending from about 1 nanometer to about 50 nanometers. In still other embodiments, each nanocrystal NC may have cross-sectional dimensions in a range extending from about 1 nanometer to about 20 nanometers. By way of example and not limitation, each nanocrystal may be generally spherical, having an average diameter between about 1 nanometer and about 50 nanometers. More particularly, each nanocrystal may be generally spherical, having an average diameter between about 1 nanometer and about 20 nanometers.

In some embodiments, each nanocrystal NC may comprise a substantially pure element. In additional embodiments, each nanocrystal NC may include a binary, tertiary, or quaternary compound. Each nanocrystal NC may comprise one or more elements selected from groups 2(IIA), 12(IIB), 13(IIIB), 14(IVB), 15(VB), and 16(VIB) of the periodic table. Additionally, each nanoparticle may comprise a metallic material such as, for example, gold, silver, platinum, copper, iridium, palladium, iron, nickel, cobalt, titanium, zinc, alloys thereof, or oxides thereof (such as, for example, Fe₂O₃, CoO, NiO). In other embodiments, each nanocrystal may comprise a semiconductive material. By way of example and not limitation, each nanocrystal NC may comprise a III-V type semiconductor material (including, but not limited to, InP, InAs, GaAs, GaN, GaP, Ga₂S₃, In₂S₃, In₂Se₃, In₂Te₃, InGaP, and InGaAs), or a II-VI type semiconductor material (including, but not limited to, ZnO, CdSe, CdS, CdTe, ZnS, ZnSe, ZnTe, HgS, HgSe, and HgTe).

Optionally, each nanocrystal NC may have a core-shell structure. For example, each nanocrystal NC may have an inner core region comprising a semiconductive material and an outer shell region comprising a passive inorganic material.

Each nanocrystal NC may have an inner core region comprising: (a) a first element selected from groups 2, 12, 13 or 14 of the periodic table of the elements and a second element selected from group 16 of the periodic table of the elements; (b) a first element selected from group 13 of the periodic table of the elements and a second element selected from group 15 of the periodic table of the elements; or (c) an element selected from group 14 of the periodic table of the elements. Examples of materials suitable for use in the semiconductive core include, but are not limited to, CdSe, CdTe, CdS, ZnSe, InP, InAs, or PbSe. Additional examples include MgS, MgSe, MgTe, CaS, CaSe, CaTe, SrS, SrSe, SrTe, BaS, BaSe, BaTe, ZnS, ZnTe, HgS, HgSe, HgTe, Al₂S₃, Al₂Se₃, Al₂Te₃, Ga₂S₃, Ga₂Se₃, GaTe, In₂S₃, In₂Se₃, InTe, SnS, SnSe, SnTe, PbS, PbSe, PbTe, AlP, AlAs, AlSb, GaN, GaP, GaAs, GaSb, InN, InSb, BP, Si, and Ge. Furthermore, the inner core region of each nanocrystal may comprise a binary, ternary or quaternary mixture, compound, or solid solution of any such elements or materials.

Each nanocrystal NC may have an outer shell region comprising any of the materials previously described as being suitable for the inner core region of the nanocrystals NC. The outer shell region, however, may include a material that differs from the material of the inner core region. By way of example and not limitation, the outer shell region of each nanocrystal NC may include CdSe, CdS, ZnSe, ZnS, CdO, ZnO, SiO₂, Al₂O₃, or ZnTe. Additional examples include MgO, MgS, MgSe, MgTe, CaO, CaS, CaSe, CaTe, SrO, SrS, SrSe, SrTe, BaO, BaS, BaSe, BaTe, CdTe, HgO, HgS, Al₂S₃, Al₂Se₃, Al₂Te₃, Ga₂O₃, Ga₂S₃, Ga₂Se₃, Ga₂Te₃, In₂O₃, In₂S₃, In₂Se₃, In₂Te₃, GeO₂, SnO, SnO₂, SnS, SnSe, SnTe, PbO, PbO₂, PbS, PbSe, PbTe, AlN, AlP, AlAs, AlSb, GaN, GaP, GaAs, GaSb, InN, and BP. Furthermore, the outer shell region of each nanocrystal NC may include a semiconductive material or an electrically insulating (i.e., non-conductive) material. Optionally, each nanocrystal NC may include an organic or other coating that is selected to facilitate dispersion of the nanocrystals NC within a medium.

In Reaction (I) set forth above, the binding group BG may be any functional group or structure that can either coordinate with or form a covalent bond with the nanocrystals NC so as to be chemically attached to the nanocrystals NC. By way of example and not limitation, these functional groups may include at least one electron pair donor group (which may be electrically neutral or negatively charged). Electron pair donor groups often include atoms such and O, N, S, and P, as well as P═O groups. By way of example and not limitation, the binding group BG may include a primary, secondary or tertiary amine or amide group, a nitrile group, an isonitrile group, a cyanate group, an isocyanate group, a thiocyanate group, an isothiocyanate group, an azide group, a thio group, a thiolate group, a sulfide group, a sulfinate group, a sulfonate group, a phosphate group, a hydroxyl group, an alcoholate group, a phenolate group, a carbonyl group, a carboxylate group, a phosphine group, a phosphine oxide group, a phosphonic acid group, a phosphoramide group, a phosphate group, a phosphate group, as well as combinations and mixtures of such groups.

In Reaction (I), Z and Z₁, if present, each may include an alkyl, substituted alkyl, alkylene, alkenylene, substituted alkylene, substituted alkenylene, heteroalkylene, heteroalkenylene, substituted heteroalkylene, substituted heteroalkenylene, arylene, heteroarylene, substituted arylene, substituted heteroarylene, or a combination thereof. Furthermore, the chemical structure of Z may be identical to, or different from, the chemical structure of Z₁.

As previously discussed, the first functional group FG₁ and the second functional group FG₂ may be capable of reacting with one another so as to form a covalently bonded link between the chemical structure to which the first functional group FG₁ is attached and the chemical structure to which the second functional group FG₂ is attached. By way of example and not limitation, one of the first functional group FG₁ and the second functional group FG₂ may include any nucleophile (such as, for example, amines, alcohols, thiols, etc.), and the other of the first functional group FG₁ and the second functional group FG₂ may include any functional group capable of reacting with such nucleophiles (such as, for example, aldehydes, isocyanates, isothiocyanates, succinimidyl esters, sulfonly chlorides, epoxides, bromides, chlorides, iodides, and maleimides). As one example of an embodiment of the present invention, one of the first functional group FG₁ and the second functional group FG₂ may include an amine, the other of the first functional group FG₁ and the second functional group FG₂ may include an aldehyde. An imine bond (C═N) may be formed by a reaction therebetween, which may provide a covalently bonded link between the chemical structure to which the amine was attached and the chemical structure to which the aldehyde was attached. As another example, one of the first functional group FG₁ and the second functional group FG₂ may include an amine, the other of the first functional group FG₁ and the second functional group FG₂ may include a succinimidyl ester, and an amide bond may be formed by a reaction therebetween. The reaction may provide a covalently bonded link between the chemical structure to which the amine was attached and the chemical structure to which the succinimidyl ester was attached.

As previously noted, Species II is a polymer material, Ar₁ represents a first aromatic ring system, and Ar₂ represents a second aromatic ring system. In some embodiments, Ar₁ may be the same as Ar₂. In other embodiments, Ar₁ may be different from Ar₂.

By way of example and not limitation, each of the first aromatic ring system Ar₁ and the second aromatic ring system Ar₂ may be independently selected from the group consisting of: phenyl, fluorenyl, biphenyl, terphenyl, tetraphenyl, naphthyl, anthryl, pyrenyl, phenanthryl, thiophenyl, pyrrolyl, furanyl, imidazolyl, triazolyl, isoxazolyl, oxazolyl, oxadiazolyl, furazanyl, pyridyl, bipyridyl, pyridazinyl, pyrimidyl, pyrazinyl, triazinyl, tetrazinyl, benzofuranyl, benzothiophenyl, indolyl, isoindazolyl, benzimidazolyl, benzotriazolyl, benzoxazolyl, quinolyl, isoquinolyl, cinnolyl, quinazolyl, naphthyridyl, phthalazyl, phentriazyl, benzotetrazyl, carbazolyl, dibenzofuranyl, dibenzothiophenyl, acridyl, and phenazyl. In additional embodiments of the invention, the first aromatic ring system Ar₁ and the second aromatic ring system Ar₂ may be independently selected from the group consisting of: fluorenyl, terphenyl, tetraphenyl, pyrenyl, phenanthryl, pyrrolyl, furanyl, imidazolyl, triazolyl, isoxazolyl, oxadiazolyl, furazanyl, pyridazinyl, pyrimidyl, pyrazinyl, triazinyl, tetrazinyl, benzofuranyl, benzothiophenyl, indolyl, isoindazolyl, benzimidazolyl, benzotriazolyl, benzoxazolyl, quinolyl, isoquinolyl, cinnoiyl, quinazolyl, naphthyridyl, phthalazyl, phentriazyl, benzotetrazyl, carbazolyl, dibenzofuranyl, dibenzothiophenyl, acridyl, and phenazyl.

Each of the first aromatic ring system Ar₁ and the second aromatic ring system Ar₂ optionally may include additional chemical structure or side groups R₁. Optionally, the first aromatic ring system Ar₁ may have one additional side group R₁. In additional embodiments, the first aromatic ring system Ar₁ may have more than one additional side group R₁. Furthermore, the second aromatic ring system Ar₂ may have two side groups R₁. In additional embodiments, the second aromatic ring system Ar₂ may have no side groups R₁, only one side group R₁ or more than two side groups R₁. While each side group that is directly attached to either the first aromatic ring system Ar₁ or the second aromatic ring system Ar₂ is denoted as “R₁,” it is understood that each side group R₁ need not be structurally identical to the other side groups R₁, and each may differ from at least one of the other side groups R₁.

By way of example and not limitation, each R₁ group, may be independently selected from a hydrogen atom, an aryl group, an alkylaryl group, an arylalkyl group, and an alkyl group (optionally, one or more —CH₂— units of an alkyl group may be replaced by a moiety selected from —O—, —S—, an aryl group containing from 3 to about 14 carbon atoms, and —NR₂—, wherein each R₂ group may include a saturated acyclic hydrocarbyl group (linear or branched) containing from about 1 to about 100 carbon atoms. In some embodiments, each R₂ group may include from about 1 to about 20 carbon atoms. Furthermore, each R₂ group need not be structurally identical to the other R₂ groups, and each may differ from at least one of the other side groups R₂.

If a side group R₁ includes an aryl group, the aryl group may include, for example, a phenyl group, a fluorenyl group, a biphenyl group, a terphenyl group, a tetraphenyl group, a naphthyl group, a anthryl group, a pyrenyl group, a phenanthryl group, a thiophenyl group, a pyrrolyl group, a furanyl group, an imidazolyl group, a triazolyl group, a isoxazolyl group, a oxazolyl group, a oxadiazolyl group, a furazanyl group, a pyridyl group, a bipyridyl group, a pyridazinyl group, a pyrimidyl group, a pyrazinyl group, a triazinyl group, a tetrazinyl group, a benzofuranyl group, a benzothiophenyl group, an indolyl group, a isoindazolyl group, a benzimidazolyl group, a benzotriazolyl group, a benzoxazolyl group, a quinolyl group, a isoquinolyl group, a cinnolyl group, a quinazolyl group, a naphthyridyl group, a phthalazyl group, a phentriazyl group, a benzotetrazyl group, a carbazolyl group, an adibenzofuranyl group, a dibenzothiophenyl group, an acryidyl group, and a phenazyl group.

In some embodiments of the invention, if a side group R₁ includes an aryl group, the aryl group may include, for example, a fluorenyl group, a terphenyl group, a tetraphenyl group, a pyrenyl group, a phenanthryl group, a thiophenyl group, a pyrrolyl group, a furanyl group, an imidazolyl group, a triazolyl group, an isoxazolyl group, an oxadiazolyl group, a furazanyl group, a pyridazinyl group, a pyrimidyl group, a pyrazinyl group, a triazinyl group, a tetrazinyl group, a benzofuranyl group, a benzothiophenyl group, an indolyl group, an isoindazolyl group, a benzimidazolyl group, a benzotriazolyl group, a benzoxazolyl group, a quinolyl group, an isoquinolyl group, a cinnolyl group, a quinazolyl group, a naphthyridyl group, a phthalazyl group, a phentriazyl group, a benzotetrazyl group, a carbazolyl group, a dibenzofuranyl group, a dibenzothiophenyl group, an acridyl group, and a phenazyl group.

As previously discussed, in Reaction (I) above, L₁ and L₂ represent optional chemical structure providing a covalently bonded link between Ar₁ and Ar₂. In some embodiments of the invention, L₁ and L₂ may be identical. In other embodiments, L₁ may be different from L₂. In yet other embodiments, L₁ may be absent, L₂ may be absent, or both L₁ and L₂ may be absent. In such embodiments, direct covalent bonds may be provided between at least some of the first aromatic ring systems Ar₁ and the second aromatic ring systems Ar₂. By way of example and not limitation, each of L₁ and L₂ independently may include an imine group, a diazo group, an ethenyl group, an ethynyl group, acetylene, substituted acetylene, ethene, substituted ethene, —CH═N—, and —N═N—, or any other double-bonded chemical structure to form the conjugated polymer material of Species III.

As particular examples of embodiments of the present invention, Species II may be one of the following: a poly(p-phenylene vinylene) (PPV) derivative, a poly(p-pyridine vinylene (PPyV) derivative, a poly(p-pryidine) (PPy) derivative, a poly (distryryl benzene) (DSB) derivative, a poly(p-phynylene) (PPP) derivative, an α-sexithiophene (α-6T) derivative, a polyaniline (PANI) derivative, a poly(p-phynylene ethynylene) (PPE) derivative, a poly(thiophene) derivative, and a poly(fluorine) (PFO) derivative.

By way of example and not limitation, Species II may comprise one of the following: 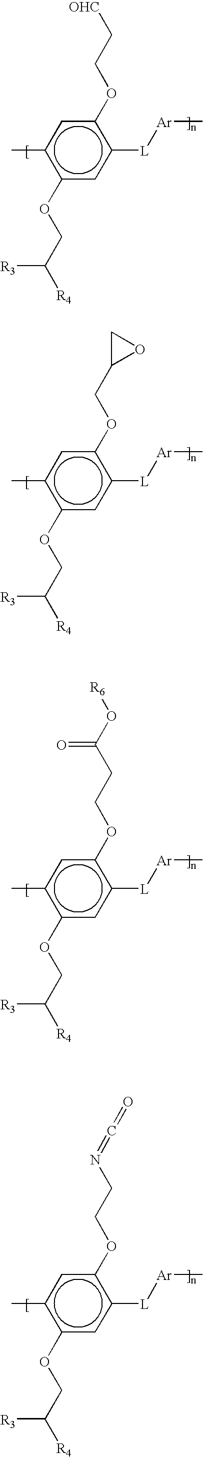
, where L is an optional chemical structure that comprises any group described above that is suitable for use as L₁ and L₂ in Reaction (I) (or L may be absent), Ar comprises any aromatic ring system previously described as being suitable for use as Ar₁ or Ar₂ in Reaction (I), and wherein R₃, R₄, and R₅ each include an alkyl group, an alkenyl group, an alkoxy group, or an aryl group. Furthermore, in some embodiments, R₃, R₄, and R₅ each may be identical to one another. In other embodiments, R₃, R₄, and R₅ each may be different from one another. Moreover, R₃ and R₄ may be identical to one another and different from R₅, or R₃ and R₄ may be different from one another and R₅ may be identical to R₃ or R_{4.} In some embodiments, each of R₃, R₄, and R₅ may include from 1 to 100 carbon atoms. More particularly, each of R₃, R₄, and R₅ each may include from 1 to about 20 carbon atoms.

In additional embodiments, Species II may comprise one of the following: 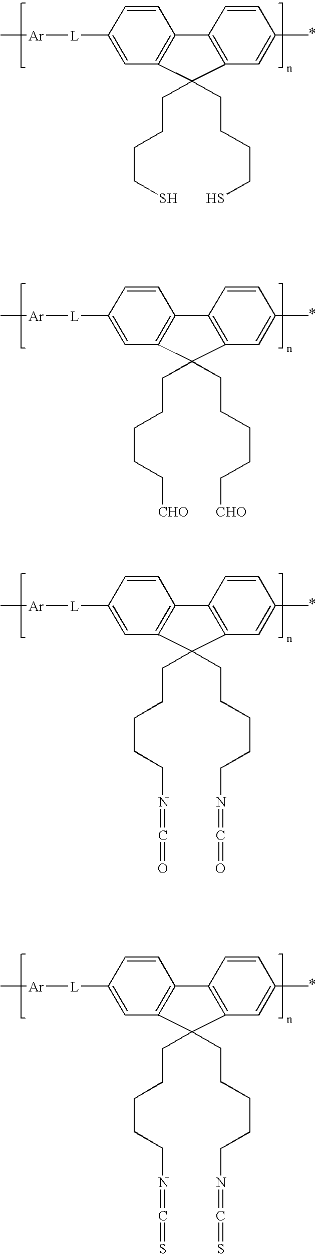
, where L is optional chemical structure that comprises any group described above as suitable for use as L₁ and L₂ in Reaction (I) (or L may be absent), and Ar comprises any aromatic ring system previously described as being suitable for use as Ar₁ or Ar₂ in Reaction (I).

In Species II and Species III shown in Reaction (I) above, m may be any integer between about 1,000 and about 10,000, and n may be any integer between 1 and about 5,000. In some embodiments, n may be any integer between 1 and about 1,000. In yet additional embodiments, n may be any integer between 1 and about 30. By selectively tailoring the value of n, the number and density of nanocrystals NC in Species III (the nanocrystal-polymer composite material) may be selectively controlled, thereby selectively controlling any of the physical properties exhibited by Species III that are at least partially a function of the number and density of the nanocrystals NC in Species III.

Example (I)(A) below is a specific example of the reaction represented by Reaction (I) above.

### EXAMPLE (IA)

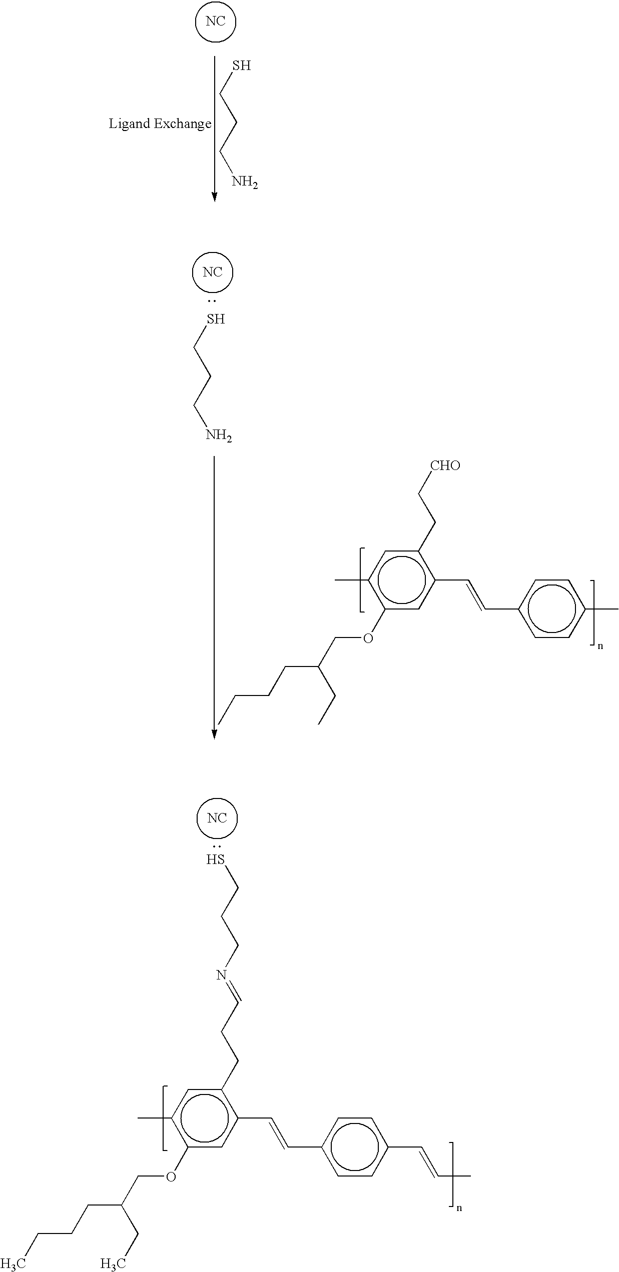

Example (I)(A) set forth above provides a nanocrystal-polymer composite material comprising a poly(phenylene vinylene) (PPV) derivative matrix polymer material and nanocrystals chemically attached to the PPV backbone by way of a chemical complex formed between the nanocrystal and a binding group (the binding group comprising a sulfur atom, in the above example) and a covalent bond linking the binding group and the PPV backbone. In this particular example, the covalently bonded link is formed by providing an aldehyde group on a plurality of side chain groups extending from the PPV backbone, providing a primary amine group on the ligand, which is chemically attached to the nanocrystal NC by way of the binding group, and reacting the primary amine group with the aldehyde group to form a —CH═N— linkage between the ligand and the side chain group.

In another embodiment of the present invention, at least two ligands may be provided and may be chemically attached to each of a plurality of nanocrystals. Each ligand may include a binding group that is configured to form a chemical bond or a chemical complex with a nanocrystal. Each ligand may also include a functional group that is configured to react with a functional group provided on a molecule of a polymer matrix material. The nanocrystals having the ligands bound thereto then may be mixed with the molecules of the polymer matrix material. This general reaction is set forth below as Reaction (II).

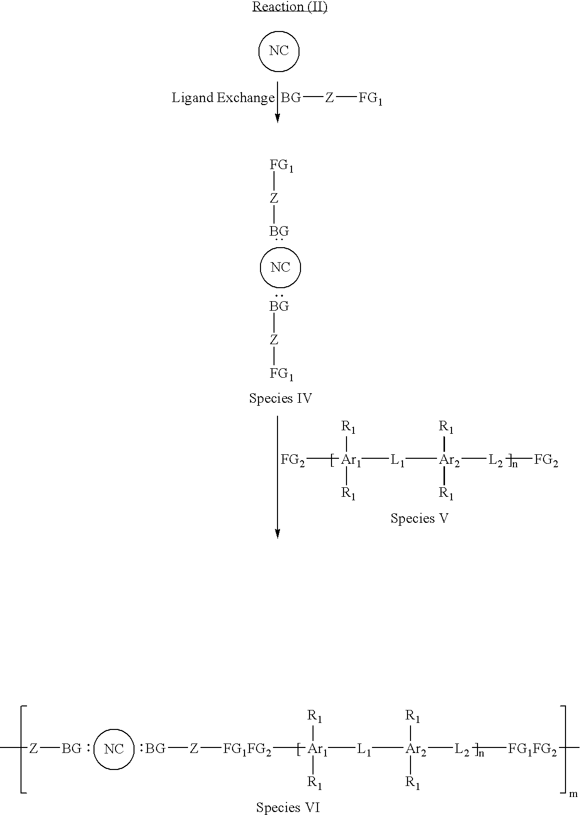

In Reaction (II) as set forth above, NC is a nanocrystal, Species IV is a nanocrystal NC having two or more ligands chemically attached thereto, Species V is a polymer material, Species VI is a nanocrystal-polymer composite material in which nanocrystals are chemically attached to the molecules of the polymer matrix material, BG is a binding group, FG₁ is a first functional group, FG₂ is a second functional group that is capable of reacting with the first functional group FG₁ to form a covalently bonded link therebetween, FG₁FG₂ is the resulting chemical structure formed by a reaction between FG₁ and FG₂, Z represents optional chemical structure providing a covalently bonded link between the binding group BG and the first functional group FG₁, Ar₁ represents a first aromatic ring system, Ar₂ represents a second aromatic ring system, and L₁ and L₂ represent optional chemical structure providing a covalently bonded link between Ar₁ and Ar₂. Moreover, each R₁ represents optional additional chemical structure(s).

In Reaction (II), the nanocrystal NC, binding group BG, first functional group FG₁, second functional group FG₂, optional chemical structure Z, first aromatic ring system A₁, second aromatic ring system A₂, optional chemical structure L₁, optional chemical structure L₂, and optional side groups R₁, each may be as previously described herein in relation to Reaction (I) and Species I, Species II, and Species III.

In some embodiments of Reaction (II), at least one R₁ group may include a “tuning group,” having a chemical structure configured to tune solubility of Species V and/or Species VI with respect to a solvent material, to tune at least one optical characteristic (e.g., color purity) exhibited by Species V and/or Species VI, or to both tune the solubility and at least one optical characteristic exhibited by Species V and/or Species VI. By way of example and not limitation, such a tuning group may be or may include an alkylene group, an alkenylene group, a substituted alkylene group, a substituted alkenylene group, a heteroalkylene group, a heteroalkenylene group, a substituted heteroalkylene group, a substituted heteroalkenylene group, an arylene group, a heteroarylene group, a substituted arylene group, a substituted heteroarylene group, or a combination of any of the above. Furthermore, in some embodiments, such a tuning group may be covalently linked to the first aromatic ring system Ar₁ or the second aromatic ring system Ar₂ by way of a heteroatom.

In Species V and Species VI shown in Reaction (II) above, n may be any integer between 1 and about 10,000. In some embodiments, n may be any integer between 1 and about 1,000. In yet other embodiments, n may be any integer between 1 and about 30. By selectively tailoring the value of n, the number and density of nanocrystals NC in Species VI (the nanocrystal-polymer composite material) may be selectively controlled, thereby selectively controlling any of the physical properties exhibited by Species VI that are at least partially a function of the number and density of the nanocrystals NC in Species VI.

Example (II)(A) below is an example of the reaction represented by Reaction (I) above.

### EXAMPLE (II)(A)

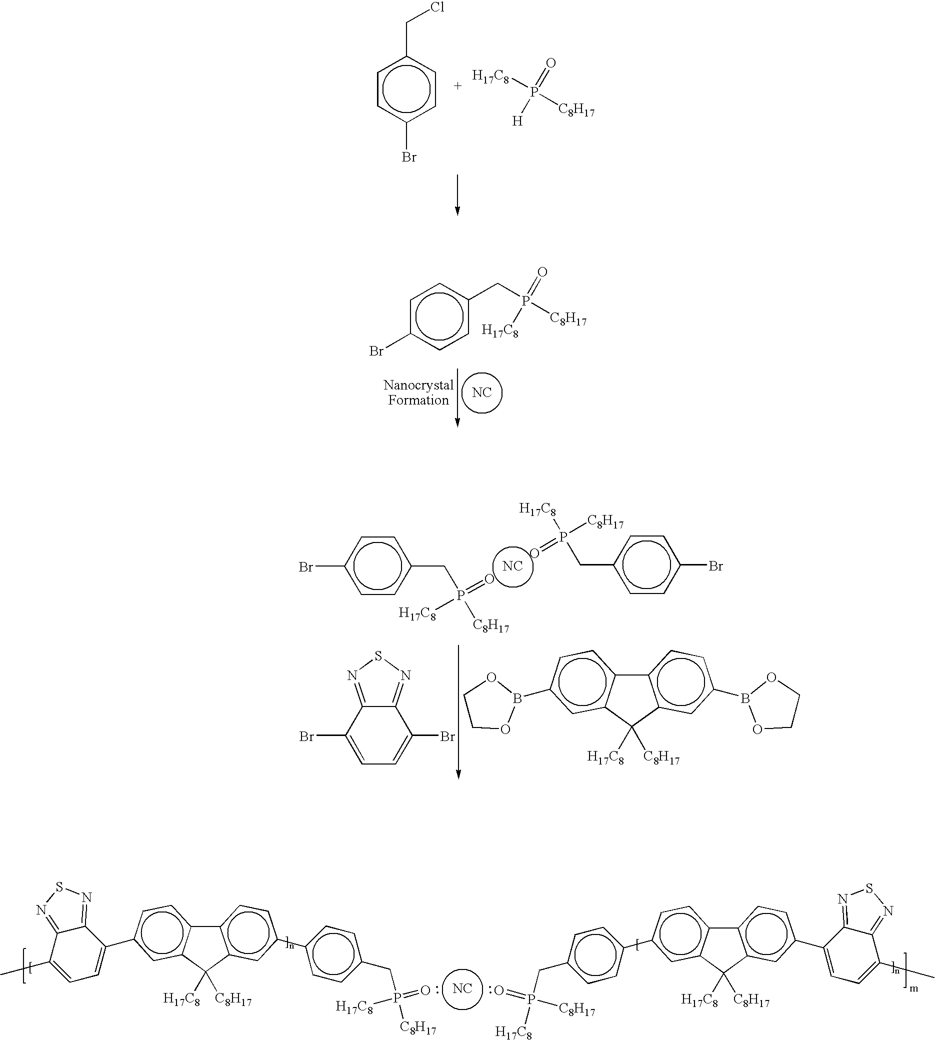

Example (II)(A) set forth above produces a nanocrystal-polymer composite material comprising a poly(fluorine benzothiadiazole) (PFO-BT) derivative matrix polymer material and nanocrystals chemically attached to the PFO-BT derivative backbone by way of a chemical complex formed between the nanocrystal and binding groups (the binding group comprising a phosphine oxide group, in the above example) and a covalently bonded link between the binding groups and the PFO-BT derivative backbone. The covalently bonded link is formed by a nucleophilic substitution reaction.

In another embodiment of the present invention, a nanocrystal-polymer matrix material may be provided that has a three-dimensional network molecular structure (often referred to as a “dendrimer” or “mesh” structure). The general reaction is set forth below as Reaction (III).

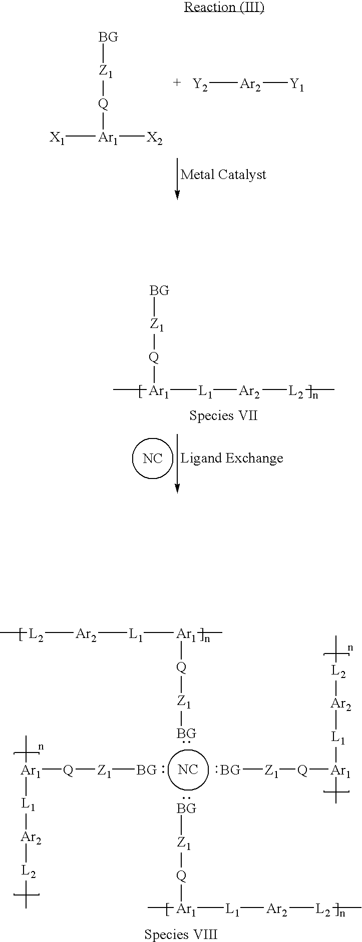

In Reaction (III) as set forth above, NC is a nanocrystal, Species VII is a polymer material, and Species VIII is a nanocrystal-polymer composite material in which nanocrystals NC are chemically attached to molecules of the polymer matrix material, BG represents a binding group, X₁ represents a functional group, Y₁ represents a functional group that is complementary to X₁ and capable of reacting therewith to form a covalently bonded link therebetween, X₂ represents a functional group, Y₂ represents a functional group that is complementary to X₂ and capable of capable of reacting therewith to form a covalently bonded link therebetween, Ar₁ represents a first aromatic ring system, Ar₂ represents a second aromatic ring system, L₁ is the resulting chemical structure formed by a reaction between X₁ and Y₁, L₂ is the resulting chemical structure formed by a reaction between X₂ and Y₂, Q represents a carbon atom or a heteroatom, and Z₁ represents optional chemical structure providing a covalently bonded link between the binding groups BG and the first aromatic ring system Ar₁.

In Reaction (III), the nanocrystal NC, binding group BG, optional chemical structure Z₁, first aromatic ring system A₁, and second aromatic ring system A₂ each may be as previously described herein in relation to Reaction (I) and Species I, Species II, and Species III.

By way of example and not limitation, X₁ and X₂ may be or may include a halogen group such as bromide or iodide. In additional embodiments, X₁ and X₂ may be triflate or tosylate. By way of example and not limitation, Y₁ and Y₂ may be or may include an organometallic functional group, boronic ester, silicon reagent, or a Grignard reagent.

Although not shown in Reaction (III), in some embodiments, one or more R₁ groups may be attached to one or both of the first aromatic ring system A₁ and the second aromatic ring system A₂. Such R₁ groups may be identical to any of those previously described in relation to Reaction (II).

Example (III)(A) below is a specific example of the general reaction represented by Reaction (III) above.

### EXAMPLE (III)(A)

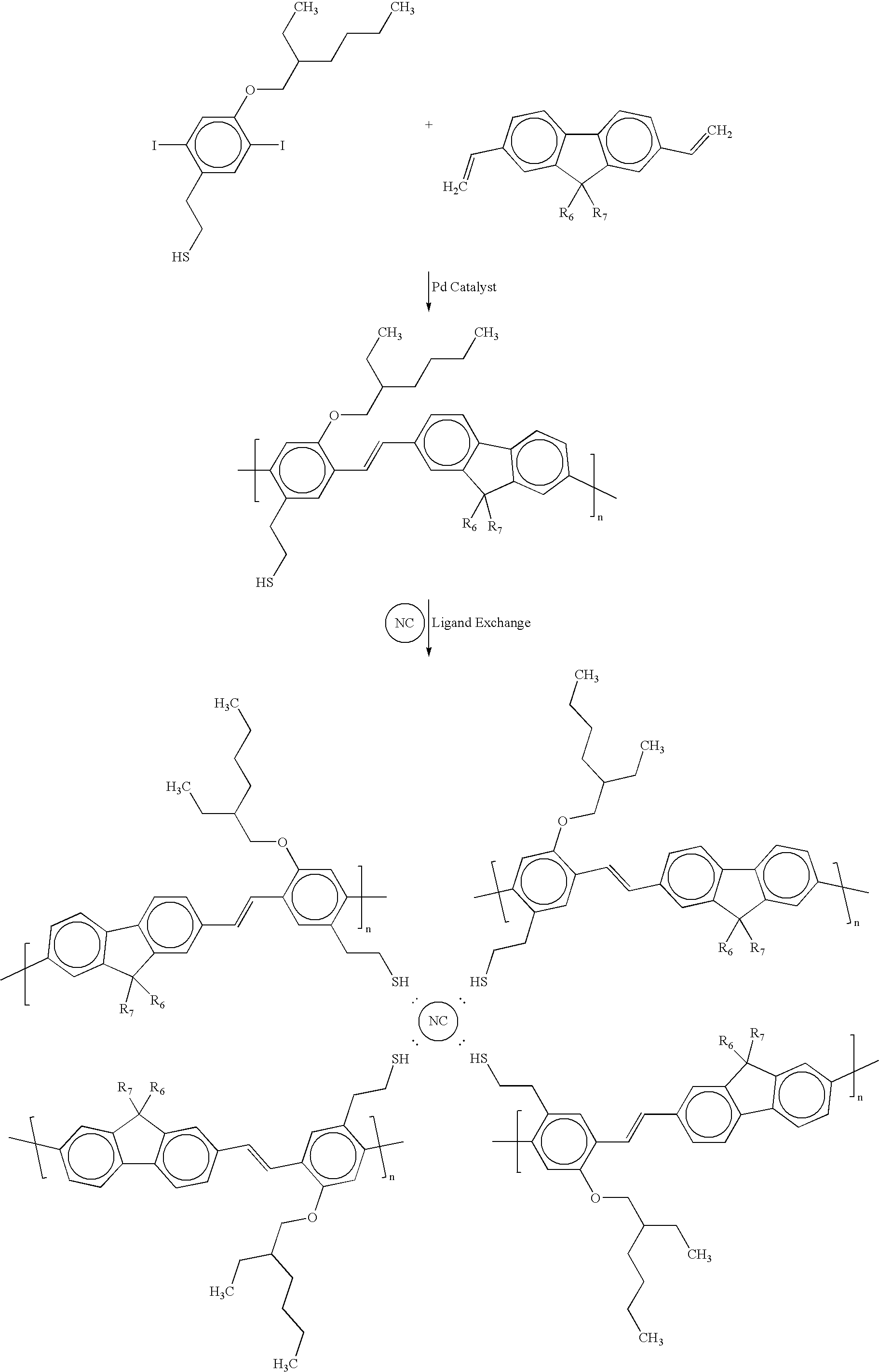

Example (III)(A) set forth above produces a nanocrystal-polymer composite material comprising a plurality of nanocrystals chemically attached to the molecular backbones of a polymer matrix material by way of a chemical complex formed between the nanocrystals and binding groups (the binding groups comprising sulfides in the above example) that are covalently bonded to the polymer molecules. Furthermore, the nanocrystal-polymer composite material produced by Example (III)(A) may have a three-dimensional network structure.

The reaction schemes described herein provide methods whereby nanocrystal-polymer composite materials may be provided that exhibit well-defined, uniform, and selected distances between the nanocrystals and the backbone of the polymer molecules. This distance may be defined by the length of the particular selected ligands that extend between the nanocrystals and the backbone of the polymer molecules. By selectively tailoring the distance between the nanocrystals and the backbone of electrically conductive polymer molecules, the transfer of energy or charge between the polymer and the nanocrystals (e.g., carrier injection, Coulombic or exchange resonance coupling, and charge screening) also may be selectively tailored.

The transfer of energy or charge between the polymer and the nanocrystals may be further enhanced by selectively tailoring the electronic energy band structure of at least one of the nanocrystals and the polymer matrix such that transfer of electrons from the allowed energy states in the conductive band of the energy band structure of the polymer material to the allowed energy states in the conductive band of the energy band structure of the nanocrystals is facilitated or enhanced. The energy band structure of the nanocrystals may be selectively tailored by, for example, adjusting the chemical composition of the nanocrystals (e.g., doping the nanocrystals with a dopant, or by mixing together different semiconductor materials). If the nanocrystals have an average particle size of less than about 10 nanometers, the energy band structure of the nanocrystals may be selectively tailored by, for example, adjusting the size of the nanocrystals. The energy band structure of the polymer matrix may be selectively tailored by, for example, adjusting the chemical composition of the polymer material (e.g., replacing side-groups or altering the structure of the polymer backbone of the polymer matrix material). The chemical composition of the polymer material may be altered by, for example, altering processing conditions during formation of the polymer matrix material, or by the addition or modification of chemical reagents used to form the polymer material.

Additionally, the reactions described herein provide methods whereby the density and distribution of the nanocrystals in the polymer matrix of nanocrystal-polymer composite materials may be selectively controlled. By selectively controlling the density and distribution of the nanocrystals in the polymer matrix, nanocrystal-polymer composite materials may be provided that exhibit selectively controlled optical or electrical properties (such as, for example, luminescence intensity, color purity, electrical conductivity, etc.).

Furthermore, by attaching nanocrystals to the molecules of the polymer matrix in a nanocrystal-polymer composite material as described herein, nanocrystal agglomeration and resulting phase separation between the nanocrystals and the polymer matrix in the nanocrystal-polymer composite material may be prevented or minimized, which may further improve electrical and/or optical properties of the nanocrystal-polymer composite material.

Electronic and optoelectronic devices (such as, for example, light-emitting diodes, display devices that include light-emitting diodes, electromagnetic radiation sensors, lasers, photovoltaic cells, photo-transistors, modulators) may be provided by incorporating nanocrystal-polymer composite materials as described herein.

An example of a light-emitting diode 10 that embodies teachings of the present invention is shown schematically in FIG. 1. As seen therein, the light-emitting diode 10 may have a generally multi-layered structure. For example, the light-emitting diode 10 may include a luminescent nanocrystal-polymer composite material 12 disposed between an anode 14 and a cathode 16. The luminescent nanocrystal-polymer composite material 12 may include nanocrystals chemically attached to molecules of a polymer matrix material as previously described herein and may be configured to emit electromagnetic radiation having one or more wavelengths within the visible region of the electromagnetic spectrum (e.g., between about 400 nanometers and about 750 nanometers) upon stimulation. The luminescent nanocrystal-polymer composite material 12 may be stimulated by applying a voltage between the anode 14 and the cathode 16, thereby generating an electric field extending across the luminescent nanocrystal-polymer composite material 12.

The electrical field between the anode 14 and the cathode 16 may generate excitons (e.g., electron-hole pairs) in the luminescent nanocrystal-polymer composite material 12. The luminescent nanocrystal-polymer composite material 12 may be selectively configured such that the allowed electron-hole energy states of the polymer matrix material and the nanocrystals facilitate transfer of excitons in the polymer matrix material to the nanocrystals. As the excitons in the nanocrystals collapse, a photon of electromagnetic radiation having energy (i.e., a wavelength or frequency) corresponding to the energy of the exciton may be emitted.

By way of example and not limitation, the anode 14 may include a layer of transparent indium tin oxide (ITO), and the cathode 16 may comprise a layer of aluminum. Various other materials that can be used to form the anode 14 and the cathode 16 are known in the art and any such materials may be used to provide the anode 14 and the cathode 16 of the light-emitting diode 10.

Optionally, the light-emitting diode 10 may include a hole transport layer 15 configured to facilitate the transfer of holes from the anode 14 into the luminescent nanocrystal-polymer composite material 12. Furthermore, the light-emitting diode 10 may include an electron transport layer 17 configured to facilitate the transfer of electrons from the cathode 16 into the luminescent nanocrystal-polymer composite material 12. Such hole transport layers 15 and electron transport layers 17 are known in the art. By way of example and not limitation, the hole transport layer 15 may include a layer of Poly(3,4-ethylenedioxythiophene) poly(styrenesulfonate) (PEDOT/PSS), and the electron transport layer 17 may include, for example, a layer of tris(8-hydroxyquinolinato)aluminum (Alq3).

Moreover, many other material layers for enhancing the efficiency of light-emitting diodes optionally may be provided in the light-emitting diode 10. Such material layers may include, for example, hole injecting layers disposed between the anode 14 and the hole transport layer 15, and electron injecting layers disposed between the cathode 16 and the electron transport layer 17.

By utilizing a luminescent nanocrystal-polymer composite material 12 in which the nanocrystals are chemically attached to the molecules of the polymer matrix material as previously described herein, the electrical and/or optical properties of the light-emitting diode 10 may be enhanced relative to previously known light-emitting diodes.

Although the foregoing description contains many specifics, these are not to be construed as limiting the scope of the present invention, but merely as providing certain representative embodiments. Similarly, other embodiments of the invention can be devised which do not depart from the spirit or scope of the present invention. The scope of the invention is, therefore, indicated and limited only by the appended claims and their legal equivalents, rather than by the foregoing description. All additions, deletions, and modifications to the invention, as disclosed herein, which fall within the meaning and scope of the claims, are encompassed by the present invention.

What is claimed is:

1. A nanocrystal-polymer composite material comprising:
a polymer matrix material; and
a plurality of nanocrystals, wherein a chemical complex or a covalent bond chemically attaches each nanocrystal to a molecule of the polymer matrix material.

2. The composite material of claim 1, wherein the polymer matrix material comprises an electrically conductive polymer matrix material.

3. The composite material of claim 1, wherein the plurality of nanocrystals has an average nanocrystal size in a range extending from about 1 nanometer to about 20 nanometers.

4. The composite material of claim 1, wherein the composite material has the structure 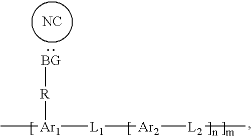
wherein
NC is a nanocrystal;
BG is a binding group selected from the group consisting of a primary amine, a secondary amine, a tertiary amine, an amide, a nitrile, an isonitrile, a cyanate, an isocyanate, a thiocyanate, an isothiocyanate, an azide, a thio, a thiolate, a sulfide, a sulfinate, a sulfonate, a phosphate, a hydroxyl, an alcoholate, a phenolate, a carbonyl, a carboxylate, a phosphine, a phosphine oxide, a phosphonic acid, a phosphoramide, a phosphate, and a phosphate;
Ar₁ and Ar₂ each comprise an aromatic ring system;
R comprises a chemical structure providing a covalent bond link between BG and AR₁; and
L₁ and L₂ each comprise a covalent bond or chemical structure providing a covalent bond link;
m is an integer greater than about 1,000; and
n is an integer between 1 and about 5,000.

5. The composite material of claim 4, wherein each nanocrystal of the plurality of nanocrystals comprises a metallic material or a semiconductive material.

6. The composite material of claim 4, further comprising additional chemical structure attached to at least one of Ar₁ and Ar₂.

7. The composite material of claim 4, wherein at least one of Ar₁ and Ar₂ has the structure 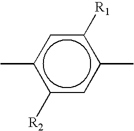
wherein R₁ and R₂ are hydrogen or additional chemical structure, or at least one of Ar₁ and Ar₂ has the structure 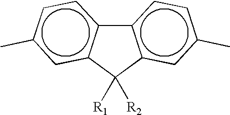
wherein R₁ and R₂ are hydrogen or additional chemical structure.

8. The composite material of claim 1, wherein the composite material has the structure 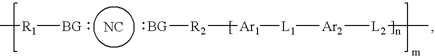
wherein
NC is a nanocrystal;
each BG is a binding group independently selected from the group consisting of a primary amine, a secondary amine, a tertiary amine, an amide, a nitrile, an isonitrile, a cyanate, an isocyanate, a thiocyanate, an isothiocyanate, an azide, a thio, a thiolate, a sulfide, a sulfinate, a sulfonate, a phosphate, a hydroxyl, an alcoholate, a phenolate, a carbonyl, a carboxylate, a phosphine, a phosphine oxide, a phosphonic acid, a phosphoramide, a phosphate, and a phosphate;
Ar₁ and Ar₂ each comprise an aromatic ring system;
R₁ and R₂ each comprise chemical structure providing a covalent bond link; and
L₁ and L₂ each comprise a covalent bond or chemical structure providing a covalent bond link;
m is an integer greater than about 1,000; and
n is an integer between 1 and about 5,000.

9. The composite material of claim 8, wherein Ar₁ and Ar₂ are structurally identical.

10. The composite material of claim 8, wherein at least one of Ar₁ and Ar₂ has the structure 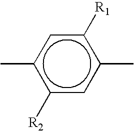
wherein R₁ and R₂ each is independently hydrogen or additional chemical structure, or wherein at least one of Ar₁ and Ar₂ has the structure 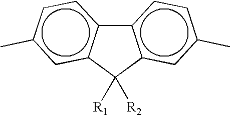
wherein R₁ and R₂ each is independently hydrogen or additional chemical structure.

11. A method of chemically attaching each of a plurality of nanocrystals to at least one molecule of a polymer matrix material, the method comprising:
coating a plurality of nanocrystals with ligands having the structure
BG-Z-FG₁,
wherein
BG is a binding group independently selected from the group consisting of a primary amine, a secondary amine, a tertiary amine, an amide, a nitrile, an isonitrile, a cyanate, an isocyanate, a thiocyanate, an isothiocyanate, an azide, a thio, a thiolate, a sulfide, a sulfinate, a sulfonate, a phosphate, a hydroxyl, an alcoholate, a phenolate, a carbonyl, a carboxylate, a phosphine, a phosphine oxide, a phosphonic acid, a phosphoramide, a phosphate, and a phosphate;
Z is a covalent bond or chemical structure providing a covalent bond between BG and FG₁; and
FG₁ is a first functional group;
providing a polymer material having the structure 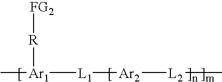
wherein
Ar₁ and Ar₂ each comprise an aromatic ring system;
R is a covalent bond or chemical structure providing a covalent bond link between FG₂ and AR₁;
FG₂ is a second functional group configured to react with the first functional group FG₁ to provide a covalent bond link between BG and Ar₁;
L₁ and L₂ each comprise a covalent bond or chemical structure providing a covalently bonded link;
m is an integer greater than about 1,000; and
n is an integer between 1 and about 5,000; and
reacting the FG₂ groups with the FG₁ groups to form covalent bond links between BG and Ar₁.

12. The method of claim 11, wherein at least one of Ar₁ and Ar₂ has the structure 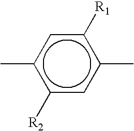
wherein R₁ and R₂ are hydrogen or additional chemical structure, or at least one of Ar₁ and Ar₂ has the structure 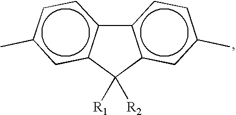
wherein R₁ and R₂ are hydrogen or additional chemical structure.

13. A method of chemically attaching each of a plurality of nanocrystals to at least one molecule of a polymer matrix material, the method comprising:
providing a polymer material having the structure 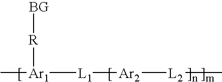
wherein
BG is a binding group independently selected from the group consisting of a primary amine, a secondary amine, a tertiary amine, an amide, a nitrile, an isonitrile, a cyanate, an isocyanate, a thiocyanate, an isothiocyanate, an azide, a thio, a thiolate, a sulfide, a sulfinate, a sulfonate, a phosphate, a hydroxyl, an alcoholate, a phenolate, a carbonyl, a carboxylate, a phosphine, a phosphine oxide, a phosphonic acid, a phosphoramide, a phosphate, and a phosphate;
Ar₁ and Ar₂ each comprise an aromatic ring system;
R is a covalent bond or chemical structure providing a covalent bond link between FG₂ and AR₁;
L₁ and L₂ each comprise a covalent bond or chemical structure providing a covalent bond link;
m is an integer greater than about 1,000; and
n is an integer between 1 and about 5,000; and
providing a plurality of nanocrystals; and
forming a chemical complex or a covalent bond between each nanocrystal and a binding group BG.

14. The method of claim 13, wherein providing a plurality of nanocrystals comprises forming the plurality of nanocrystals in situ within the polymer material.

15. The method of claim 13, wherein at least one of Ar₁ and Ar₂ has the structure 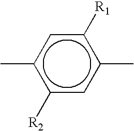
wherein R₁ and R₂ are hydrogen or additional chemical structure, or at least one of Ar₁ and Ar₂ has the structure 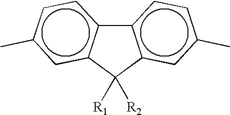
wherein R₁ and R₂ are hydrogen or additional chemical structure.

16. A method of chemically attaching each of a plurality of nanocrystals to at least one molecule of a polymer matrix material, the method comprising:
coating a plurality of nanocrystals with ligands having the structure
BG-Z-FG₁,
wherein
BG is a binding group independently selected from the group consisting of a primary amine, a secondary amine, a tertiary amine, an amide, a nitrile, an isonitrile, a cyanate, an isocyanate, a thiocyanate, an isothiocyanate, an azide, a thio, a thiolate, a sulfide, a sulfinate, a sulfonate, a phosphate, a hydroxyl, an alcoholate, a phenolate, a carbonyl, a carboxylate, a phosphine, a phosphine oxide, a phosphonic acid, a phosphoramide, a phosphate, and a phosphate;
Z is a covalent bond or chemical structure providing a covalent bond link between BG and FG₁, and
FG₁ is a first functional group;
providing a polymer material having the structure 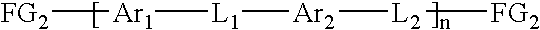
wherein
Ar₁ and Ar₂ each comprise an aromatic ring system;
R is a covalent bond or chemical structure providing a covalent bond link between FG₂ and AR₁;
FG₂ is a second functional group configured to react with the first functional group FG₁ to provide a covalent bond link between BG and Ar₁;
L₁ and L₂ each comprise a covalent bond or chemical structure providing a covalent bond link; and
n is an integer between 1 and about 5,000; and
reacting the FG₂ groups with the FG₁ groups to form covalent bond links.

17. The method of claim 16, wherein at least one of Ar₁ and Ar₂ has the structure 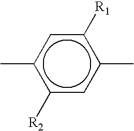
wherein R₁ and R₂ each is independently hydrogen or additional chemical structure, or at least one of Ar₁ and Ar₂ has the structure 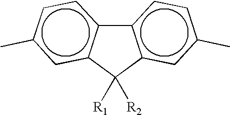
wherein R₁ and R₂ each is independently hydrogen or additional chemical structure.

18. An electronic device comprising at least one light-emitting diode, the at least one light-emitting diode comprising:
an anode;
a cathode; and
a luminescent nanocrystal-polymer composite material disposed between at least a portion of the anode and a portion of the cathode, the luminescent nanocrystal-polymer composite material comprising:
a polymer matrix material; and
a plurality of nanocrystals, wherein a chemical complex or a covalent bond chemically attaches each nanocrystal to a molecule of the polymer matrix material.

19. The electronic device of claim 18, wherein the electronic device comprises a display device, the at least one light-emitting device comprising a plurality of light emitting devices together defining a screen configured to display an image.

20. The electronic device of claim 19, wherein the electronic device comprises one of a television, a computer monitor, a portable computer device, a handheld computer device, or a portable media player.

21. The electronic device of claim 18, wherein the polymer matrix material comprises an electrically conductive polymer matrix material.

22. The electronic device of claim 18, wherein the composite material has the structure 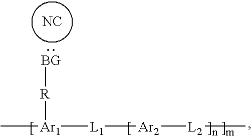
wherein
NC is a nanocrystal;
BG is a binding group selected from the group consisting of a primary amine, a secondary amine, a tertiary amine, an amide, a nitrile, an isonitrile, a cyanate, an isocyanate, a thiocyanate, an isothiocyanate, an azide, a thio, a thiolate, a sulfide, a sulfinate, a sulfonate, a phosphate, a hydroxyl, an alcoholate, a phenolate, a carbonyl, a carboxylate, a phosphine, a phosphine oxide, a phosphonic acid, a phosphoramide, a phosphate, and a phosphate;
Ar₁ and Ar₂ each comprise an aromatic ring system;
R comprises chemical structure providing a covalently bond link between BG and AR₁; and
L₁ and L₂ each comprise a covalent bond or chemical structure providing a covalent bond link;
m is an integer greater than about 1,000; and
n is an integer between 1 and about 5,000.

23. The electronic device of claim 18, wherein the composite material has the structure: 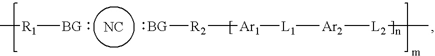
wherein
NC is a nanocrystal;
each BG is a binding group independently selected from the group consisting of a primary amine, a secondary amine, a tertiary amine, an amide, a nitrile, an isonitrile, a cyanate, an isocyanate, a thiocyanate, an isothiocyanate, an azide, a thio, a thiolate, a sulfide, a sulfinate, a sulfonate, a phosphate, a hydroxyl, an alcoholate, a phenolate, a carbonyl, a carboxylate, a phosphine, a phosphine oxide, a phosphonic acid, a phosphoramide, a phosphate, and a phosphate;
Ar₁ and Ar₂ each comprise an aromatic ring system;
R₁ and R₂ each comprise chemical structure providing a covalent bond link; and
L₁ and L₂ each comprise a covalent bond or chemical structure providing a covalent bond link;
m is an integer greater than about 1,000; and
n is an integer between 1 and about 5,000.
